(19) United States
(12) Patent Application Publication
(10) Pub. No.: US 2007/0102855 A1
(43) Pub. Date: May 10, 2007

(54) Switchable hydrobushing

(75) Inventors: Todd Wirges, Ann Arbor, MI (US); Donald Price, New Hudson, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 10/567,295

(22) PCT Filed: Aug. 6, 2004
(86) PCT No.: PCT/US04/25504

§ 371 Date: Sep. 11, 2006

Related U.S. Application Data
(60) Provisional application No. 60/492,918, filed on Aug. 6, 2003.

(51) Int. Cl. F16F 7/00

(52) U.S. Cl. 267/141.1

(57) ABSTRACT

A switchable hydraulic bushing (10) is provided in which a secondary chamber (60) is sealed so as to be air-tight and is provided with a bleed passage (38) for allowing for the free flow of air into and out of the secondary air chamber (60). A closure device (40) is provided for closing off the bleed passage (38) for sealing off the air-tight secondary chamber (60) to alter the flexibility characteristics of the walls (58) of the compensation chambers (52) and effectively turn off the hydraulic damping function of the hydraulic bushing (10).

### CROSS-REFERENCE TO RELATED APPLICATIONS

This application claims the benefit of U.S. Provisional Application No. 60/492,918, filed on Aug. 6, 2003. The disclosure of the above application is incorporated herein by reference.

### FIELD OF THE INVENTION

The present invention relates to hydraulic bushings and more particularly to a switchable hydraulic bushing.

### BACKGROUND OF THE INVENTION

Hydraulic bushings or mounts are used to dampen and reduce vibrations transmitted between an engine and a chassis in vehicles. Generally, a hydraulic engine mount includes an inner core connected to an inner support structure, commonly known as an inner ring, by an elastomeric material to form an assembly. The assembly is received in a housing. The housing is mounted to an engine and a chassis. A hydraulic fluid is provided in a chamber formed between the assembly and the housing. When the engine or chassis receives a vibration, hydraulic fluid in the engine mount is displaced into desired chambers to dampen the vibration and reduce its transmission. Although the hydraulic damping provided by the hydraulic bushing is desirable for most modes of operation, there are certain modes of operation (i.e. vibration frequencies) for which the hydraulic damping is not desirable.

### SUMMARY OF THE INVENTION

Accordingly, the present invention provides a switchable hydraulic bushing which is provided with a system for deactivating the hydraulic damping effect of the hydraulic bushing. In particular, the present invention provides a switchable hydraulic bushing mount including a housing, a core disposed in the housing and an elastomeric member bonded to an outer surface of the core and disposed in the housing. The elastomeric member combines with the housing for defining a pumping chamber and at least one compensation chamber fluidly interconnect to one another by an inertia track extending along a periphery of the elastomeric member. The compensation chamber is defined by an interior wall surface of the housing and a flexible wall portion of the elastomeric member. The flexible wall portion of the compensation chamber also defines a portion of a secondary chamber adjacent to the compensation chamber with the secondary chamber being air-tight and including a bleed passage communicating thereto. A closure device is operable for closing the bleed passage in order to seal off the secondary chamber and thereby reduce the ability of the flexible wall portion to flex and provide hydraulic damping for the hydraulic bushing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of the switchable hydraulic mount according to the principles of the present invention;

FIG. 2 is a perspective view of the elastomeric member utilized in the switchable hydraulic mount according to the principles of the present invention;

FIG. 3 is a cross-sectional view taken along the line 3-3 of FIG. 2; and

FIG. 4 is a perspective view of an inner support structure of the elastomeric member according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

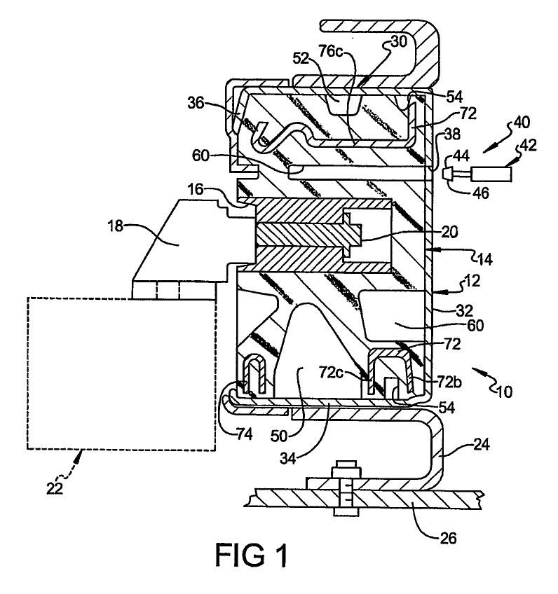

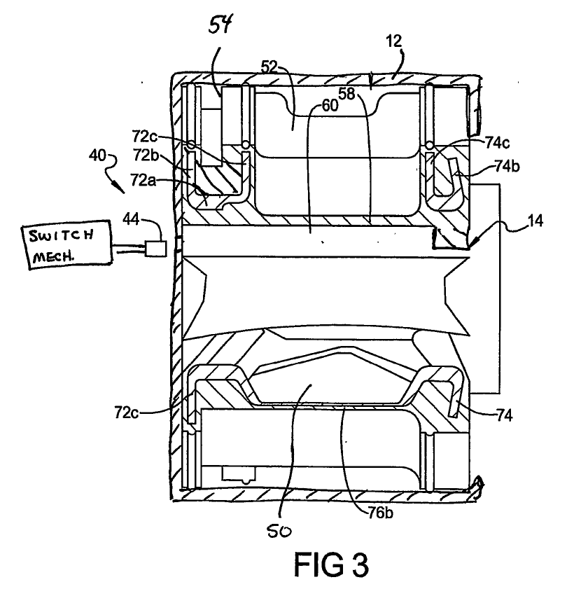

With reference to FIGS. 1 and 3, a hydraulic bushing or mount 10 is shown. The switchable hydraulic mount 10 is particularly adapted for use as an engine mount in a vehicle. However, the switchable hydraulic mount can also be utilized in other automotive applications and non-automotive applications. The hydraulic engine mount 10 includes a housing 12 commonly referred to as a can having an elastomeric member 14 received therein. The elastomeric member 14 is bonded to the outer surface of a core 16. The core 16 is mounted to a first support structure 18 by a threader fastener 20. The housing 12 is mounted to a bracket 24 which is mounted to a second support structure 26. It should be understood that the switchable hydraulic mount 10 according to the principles of the present invention can be mounted between any support members 18, 26 as is desired. In a particular application, for use as an engine mount, the support structure 18 can be fastened to an engine 22 of a vehicle while the support structure 26 can be part of a vehicle frame or body.

The housing 12 includes a cup-shaped can 30 that receives the elastomeric member 14. The can is received in the bracket 24. The can 30 includes a base portion 32 and a cylindrical side wall portion 34 extending from the base portion 32. The cylindrical side wall portion 34 has an open end with the edge 36 of the cylindrical side wall being crimped inwardly in order to retain the elastomeric member 14 therein. The can 30 includes an aperture defining a bleed passage 38 in the base portion 32 of the can 30. A closure device 40 is provided for closing off the bleed passage 38 in the can 30. The closure device 40 can include an electronic solenoid 42 which can be activated to cause a valve member 44 to engage the valve seat surface 46 surrounding the bleed passage 38.

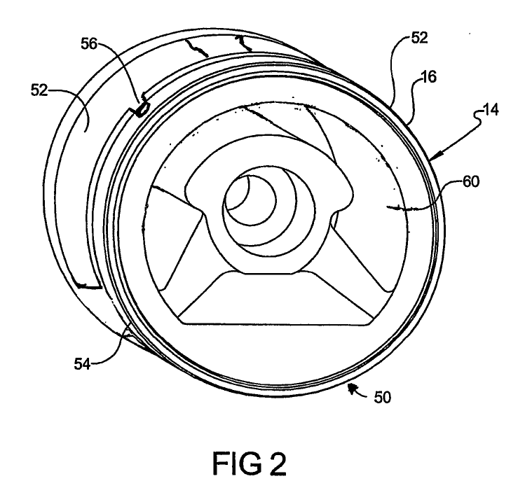

The elastomeric member 14 as illustrated FIGS. 1 and 2 include a pumping chamber 50 and a pair of compensation chambers 52 which are in fluid communication with the pumping chamber 50 via an inertia track 54 which extends around a perimeter of the elastomeric 14. In particular, as illustrated in FIG. 1, the pumping chamber 50 communicates with the inertia track 54 via an axially extending channel (not shown) that extends axially from the pumping chamber 50 to the inertia track 54. As illustrated in FIG. 2, the inertia track 54 communicates with at least one of the compensation chambers 52 via an axially extending channel 56 as illustrated in FIG. 2.

As is known in the art, the pumping chamber 50 and compensation chambers 52 are provided with hydraulic fluid therein that provides a damping function when the core element 16 is moved relative to the housing 12 thereby causing compression of the pumping chamber 50 which results in hydraulic fluid being forced through the inertia track 54 towards the compensation chambers 52. The compensation chambers have a flexible wall portion 58 as best illustrated in FIG. 3 that is capable of flexing in spring-like manner in order to absorb vibrations via the pulsing of the hydraulic fluid within the hydraulic bushing 10.

A secondary air chamber 60 is provided is provided adjacent to the flexible wall portion 58 of the compensation chamber 52 as best illustrated in FIGS. 2 and 3. The secondary chamber 60 is an air-tight chamber which communicates with the bleed passage 38 provided in the housing 12. The bleed passage 38 is intended to remain normally open to allow the free flow of air in and out of the secondary chamber 60 so that the hydraulic bushing 10 functions to properly provide a hydraulic damping function. When it is desired to switch off the hydraulic damping function, the closure device 40 is operable to close off the bleed passage 38 so as to seal the air within the secondary chamber 60. With the secondary chamber 60 sealed, the flexible wall portions 58 disposed between the compensation chambers 52 and the secondary chamber 60 have limited flexibility due to the compression of air within the secondary chamber 60 thereby limiting the motion of the flexible wall portion 58. Thus, the hydraulic damping function of the hydraulic bushing 10 is effectively switched off.

The switchable hydraulic bushing 10 of the present invention has the ability to select coupled or decoupled behavior including the presence or lack of hydraulic damping. The ability to tune and possibly to modulate the switching behavior and extent of damping is thus provided by control of the closure device 40. The switchable hydraulic bushing 10 of the present invention provides the ability to switch, via an electronically controllable switch, for several possible control situations. The system of the present invention provides a relatively low-cost implementation for providing the added switchability in the hydraulic bushing 10. Furthermore, the system provides low complexity and high manufacturing reliability.

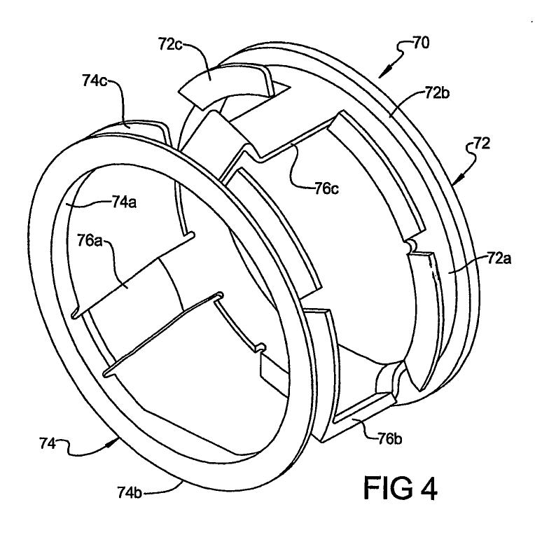

The elastomeric member 14 according to the principles of the present invention is provided with an interior support structure 70 as best illustrated in FIGS. 1, 3, and 4. The inner support structure includes a first ring 72 having an annular wall 72a and an outer end wall 72b and an inner end wall 72c. The inner support structure 70 also includes a second ring 74 including an annular wall 74aand an outer end wall 74b and an inner end wall 74c. A plurality of legs 76A-C are formed between the first and second rings 72, 74. The plurality of legs 76A-C of the inner support structure 70 include a first pair of legs, 76A, 76B that are disposed on opposite sides of the pumping chamber 50. In addition, a third leg 76C is provided between the first and second compensation chambers 52. In addition, the outer end wall 72B and inner end wall 72C of the inner support structure 70 are provided on opposite sides of the inertia track 54 to provide support thereto.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A switchable hydraulic bushing mount, comprising:
a housing;
a core disposed in said housing;
an elastomeric member bonded to an outer surface of said core and disposed in said housing, said elastomeric member combining with said housing for defining a pumping chamber and at least one compensation chamber fluidly interconnected to one another by an inertia track extending along a periphery of said elastomeric member, said compensation chamber being defined by an interior wall surface of said housing and a flexible wall portion of said elastomeric member, said flexible wall portion of said compensation chamber defining a portion of a secondary chamber adjacent to said compensation chamber, said secondary chamber being air-tight and including a bleed passage communicating thereto; and
a closure device operable for closing said bleed passage.

2. The switchable hydraulic bushing mount according to claim 1, wherein said at least one compensation chamber includes a pair of fluidly interconnected compensation chambers.

3. The switchable hydraulic bushing mount according to claim 1, wherein said elastomeric member includes an inner support structure including:
a first ring having an annular wall, an outer end wall and an inner end wall;
a second ring having an annular wall, an outer end wall and an inner end wall; and
a plurality of legs formed between the first and second rings.

4. The switchable hydraulic bushing according to claim 3, wherein said plurality of legs of said inner support structure include a first pair of legs disposed on opposite sides of said pumping chamber.

5. The switchable hydraulic bushing according to claim 4, wherein said at least one compensation chamber includes a pair of fluidly interconnected compensation chambers and wherein said plurality of legs of said inner support structure include a leg disposed between said pair of compensation chambers.

6. The switchable hydraulic bushing according to claim 3, wherein said outer end wall and said inner end wall of said first ring are disposed on opposite sides of said inertia track.

7. The switchable hydraulic bushing according to claim 1, wherein said closure device is selectively closable.

8. The switchable hydraulic bushing according to claim 1, wherein said closure device includes an activation device for moving said closure device between an open and a closed position.

9. A switchable hydraulic bushing mount, comprising:
a housing;
a core disposed in said housing;
an elastomeric member bonded to an outer surface of said core and disposed in said housing, said elastomeric member defining a pumping chamber and at least one compensation chamber fluidly interconnected to one another by a fluid passage, said compensation chamber being defined partially by a flexible wall portion of said elastomeric member, said flexible wall portion of said compensation chamber defining a portion of a secondary chamber adjacent to said compensation chamber, said secondary chamber being air-tight and including a bleed passage communicating thereto; and
a closure device operable for closing said bleed passage.

10. The switchable hydraulic bushing mount according to claim 9, wherein said at least one compensation chamber includes a pair of fluidly interconnected compensation chambers each having a flexible wall portion.

11. The switchable hydraulic bushing mount according to claim 9, wherein said elastomeric member includes an inner support structure including:
a first ring having an annular wall, an outer end wall and an inner end wall;
a second ring having an annular wall, an outer end wall and an inner end wall; and
a plurality of legs formed between the first and second rings.

12. The switchable hydraulic bushing according to claim 11, wherein said plurality of legs of said inner support structure include a first pair of legs disposed on opposite sides of said pumping chamber.

13. The switchable hydraulic bushing according to claim 12, wherein said at least one compensation chamber includes a pair of fluidly interconnected compensation chambers and wherein said plurality of legs of said inner support structure include a leg disposed between said pair of compensation chambers.

14. The switchable hydraulic bushing according to claim 11, wherein said outer end wall and said inner end wall of said first ring are disposed on opposite sides of said inertia track.

15. The switchable hydraulic bushing according to claim 9, wherein said closure device is selectively closable.

16. The switchable hydraulic bushing according to claim 9, wherein said closure device includes an activation device for moving said closure device between an open and a closed position.
